(19) United States
(12) Patent Application Publication
(10) Pub. No.: US 2025/0337212 A1
(43) Pub. Date: Oct. 30, 2025

(54) ADIABATICALLY TAPERED DOUBLE PASS FIBER ENDCAP

(71) Applicant: NORTHROP GRUMMAN SYSTEMS CORPORATION, FALLS CHURCH, VA (US)

(72) Inventor: Gregory D. Goodno, Los Angeles, CA (US)

(21) Appl. No.: 18/650,602

(22) Filed: Apr. 30, 2024

(51) Int. Cl. H01S 3/067; H01S 3/094

(52) U.S. Cl. CPC H01S 3/06745; H01S 3/094007

(57) ABSTRACT

A fiber laser system including an endcap having an input end receiving an amplified signal beam and a pump beam and an output end having a facet configured to pass the amplified signal beam and reflect the pump beam back towards the input end. The endcap includes a tapered section having a taper angle that is small enough to ensure adiabatic expansion of the numerical aperture of the pump beam and to ensure that the etendue of the pump beam is conserved between the input end and the output end, where conservation of etendue means that the NA of the pump beam decreases at the facet by the ratio of an output beam diameter of the pump beam to an input beam diameter of the pump beam. The pump beam propagates through the endcap by total internal reflection (TIR) and the amplified signal beam propagates through the endcap without TIR.

### GOVERNMENT CLAUSE

This invention was made with Government support under Contract No. FA9451-22-C-0032 awarded by the Air Force Research Laboratory. The Government has certain rights in this invention.

### BACKGROUND

### Field

This disclosure relates generally to a fiber laser pumping architecture that reduces the impact of nonlinear and thermal impairments and, more particularly, to a fiber laser pumping architecture that includes an adiabatically tapered fiber endcap that double-passes the pump light so as to reduce the impact of nonlinear and thermal impairments.

### Discussion

High power laser amplifiers have many applications including industrial, commercial, military, etc. Designers of laser amplifiers are continuously investigating ways to increase the power of the laser amplifier for these and other applications. One known type of laser amplifier is a fiber laser amplifier that employs a doped fiber, such as a ytterbium (Yb) doped fiber or a thulium (Tm) doped fiber, that receives a seed beam and a pump beam that amplifies the seed beam and generates the high power laser beam, where the fiber has an active core diameter of about 10-20 μm or larger.

Directed energy (DE) systems that direct a high energy optical beam to a target are rapidly being realized in real-world operational environments. Reliable, robust and efficient beam delivery of individual multi-kW class lasers and high energy and peak power pulsed illuminators to remote beam directors and combiners are key driving elements for DE systems. Fiber laser amplifiers have proven to be desirable as energy sources for DE systems because of their high efficiency, high power scalability and excellent beam quality. Fiber laser systems employ multiple fiber laser amplifiers that combine the amplified beams in some fashion to generate higher powers. A design challenge for fiber laser amplifier systems of this type is to combine the beams from a plurality of fiber amplifiers in a manner so that the beams provide a single beam output having a uniform phase over the beam diameter such that the beam can be focused to a small focal spot, where focusing the combined beam to a small spot at a long distance (far-field) defines the quality of the beam.

In one known multiple fiber laser amplifier design referred to as coherent beam combining (CBC), a master oscillator (MO) generates a seed beam that is split into a plurality of split seed beams each having a common wavelength, where each seed beam is amplified. The amplified seed beams are then directed to a diffractive optical element (DOE), or other optical system, that combines the coherent amplified beams into a single output beam. The DOE has a periodic structure formed into the element so that when the individual amplified beams each having a slightly different angular direction are redirected by the periodic structure all of the beams diffract from the DOE in the same direction.

In another known multiple fiber laser amplifier design referred to as spectral beam combining (SBC), a plurality of master oscillators (MOs) generate a plurality of seed beams at a plurality of different wavelengths, where each seed beam is amplified. The amplified seed beams are then directed to a diffraction grating, or other wavelength-selective element, that combines the different wavelength fiber beams into a single combined output beam. The diffraction grating has a periodic structure formed into the grating so that when the individual amplified beams each having a slightly different wavelength and angular direction are redirected by the periodic structure all of the beams diffract from the diffraction grating in the same direction.

For a typical known fiber amplifier stage, the fiber gain medium is formed as a double-clad fiber with typical cross-section diameters on the order of 20 μm for a Yb-doped signal core, 400 μm for the pump cladding and 550 μm for the outer acrylate coating. The numerical aperture (NA) of the fiber core is selected to enable a single transverse mode operation to ensure good beam quality for the signal light, typically NA˜0.06. The NA of the fiber cladding is provided as high as possible to enable coupling of low-brightness diode pump light, typically NA˜0.46. The desired low power seed beam light is injected in the fiber core, and diode pump light is co-injected into the cladding at the same end of the fiber. As the pump light propagates down the fiber it is absorbed as it crosses the core, causing the seed beam in the core to be amplified to the multi-kW level at the output. Typically, the fiber length is chosen sufficiently long to absorb 95% or more of the diode pump light.

For a packaged narrow-linewidth multi-kW fiber laser amplifier, pump and seed beam light is typically not coupled through free space, but rather is injected using specialized all-fiber components in a multi-stage chain of amplifiers. In one specific design, the seed beam is often amplified to the 10 W class in a multistage pre-amplifier before injection into the core of a dual-clad gain fiber. Diode pump light is injected into the cladding of the gain fiber using a tapered fiber bundle pump-signal combiner (PSC). After amplification, the output end the gain fiber is spliced to a passive delivery fiber. Residual pump light is stripped from the cladding using a cladding light stripper (CLS) where the acrylate coating is window-stripped, and the exposed cladding glass surface is either roughened or contacted to an index-matched adhesive to out-couple residual pump light. A wedged, antireflection (AR) coated endcap is spliced to the output end of the delivery fiber to allow the fiber mode to expand to avoid damaging the output facet, and suppress back-reflections of signal light. Typically, the amplifier is operated with a saturated gain in excess of 20 dB, and a return loss of −60 dB from the endcap is required to avoid instability or unwanted power extraction in the return direction.

Power-scaling of narrow-linewidth Yb doped fiber amplifiers is currently limited by two separate nonlinear optical impairments, specifically stimulated Brillouin scattering (SBS) and self-phase modulation (SPM), where the primary nonlinear impairment is SBS. SBS is a nonlinear effect in which the laser electric field creates a phase grating in the fiber core by electrostriction that reflects some fraction of the forward-propagating beam. If the effective reflectivity of the grating becomes too large, the output power from the fiber amplifier will decrease, with the lost power being reflected backwards towards upstream, low-power components, eventually causing catastrophic damage. Because the threshold for SBS is inversely proportional to the spectral brightness (˜power/linewidth), SBS limits the powers available from single-frequency fiber lasers to several hundred watts. To increase the threshold power for SBS, it is common practice to broaden the fiber laser input seed spectrum to the multi-GHz domain using phase modulation, or equivalently frequency modulation (FM). This reduces the optical coherence length and therefore reduces SBS gain. As the power of Yb doped fiber amplifiers increase to the multi-kW level, or as delivery fiber lengths increase, broader FM linewidths are needed to suppress SBS. Typically, the linewidth increases approximately linearly with power on the order of ˜10-20 GHz/kW for Yb doped fiber amplifiers. Reducing the SBS-limited linewidth, i.e., increasing the SBS-limited fiber spectral brightness, would enable beam-combined fiber laser system scaling to higher powers.

The optical impairment SPM is parameterized by the B-integral, i.e., the non-linear phase shift, and can degrade beam coherence by converting low levels of uncontrolled amplitude modulation (AM) into phase noise. This non-linear effect can limit the efficiency of CBC or the beam quality of SBC, hence reducing the performance of the fiber laser system. Specifically, there is a loss of spectral brightness or a loss of optical coherence. To avoid or reduce these effects, it is generally desirable to limit the amount of AM, also known as relative intensity noise (RIN), propagating in the seed beam that seeds the fiber amplifier. Techniques that broaden the spectrum of the seed beam to provide frequency modulation without providing amplitude modulation can be implemented in a fiber amplifier, where if the seed beam is only frequency modulated, then the Kerr non-linearities that drive SPM will not create problems, i.e., no time dependent non-linear phase shifts of the seed beam. However, if AM is imposed, either deliberately or inadvertently by FM-to-AM conversion, on the seed beam, then SPM can cause nonlinear spectral broadening of the beam emitted from the fiber amplifier, which could reduce beam quality during SBC.

These optical impairments typically limit the spectral brightness of the output beam, i.e., the power per unit of optical linewidth, or KW/GHz. These optical impairments grow in severity as the fiber power increases and as the fiber length increases. As fiber power increases to the multi-kW level, or as delivery fiber length increases, broader FM linewidths are needed to suppress SBS. For a co-pumped fiber amplifier, the impairment magnitude typical grows as the integral of signal power over the fiber length (colloquially known as the effective power-length product). Hence, one path to scale fiber lasers to higher power while maintaining narrow spectral linewidth is to reduce nonlinear optical impairments by decreasing the effective length of the fiber.

Although shorter fiber lengths are well known to be advantageous to reduce nonlinear optical impairments and enable spectral brightness scaling, other engineering considerations impose limits on practical minimum fiber lengths in the amplifier. For example, one engineering constraint is the need to absorb most of the pump light to ensure high optical-to-optical conversion efficiency. Yb-doped fibers suitable for high power amplifiers typically have cladding pump absorption coefficients of ˜1-1.5 dB/m. This requires gain fiber lengths on the order of 10 m to absorb >95%, or 13 dB, of the total pump light.

Another engineering constraint is the need to minimize generation of waste heat per unit fiber length. If the length of a fiber amplifier emitting a fixed power level is cut in half while maintaining the same total pump absorption (e.g., by tuning the pump wavelength to increase its effective absorption characteristic), then the waste heat per unit length will double, which causes the fiber temperature to increase. When the fiber gets too hot, its acrylate coating may burn, leading to catastrophic failure. Waste heat is particularly limiting for Tm-doped fibers emitting in the 2-μm band, since their pump absorption coefficient (˜6 dB/m) is typically ˜4-5× higher and their quantum defect (waste heat fraction, ˜35%) is 3× higher than similar geometry Yb-doped fibers emitting at 1 μm. Hence, co-pumped fiber amplifier lengths are driven by a tradeoff to balance the competing design imperatives of suppressing SBS/SPM (shorter fibers) and maintaining high absorption efficiency and low temperature (longer fibers). There is a need for fiber amplifier pump architectures that increase this tradeoff space to scale to higher spectral brightness.

One well known fiber amplifier architecture that enables higher performance by mitigating SBS and SPM switches the direction of pump light from co-propagating with the seed beam to counter-propagating with the seed beam. A pump-signal combiner is often placed at the high power output end of the amplifier, and pump cladding light is launched backwards in the direction opposite to the seed beam. This architecture has the benefit of redistributing laser gain in the amplifier toward the output end, which reduces the effective power-length product, i.e., the integral of power over the fiber length. However, the counter-pumped architecture also has several well-known drawbacks that have prevented its wide adoption in fiber laser amplifiers typically used for beam combining.

Counter-pumping results in a very high peak heat load near the output end of the fiber, where both the pump and seed beam light are at their maximum intensity and therefore laser extraction is highly saturated, which can cause thermal damage to the fiber. The PSC at the output imposes additional loss to the high power seed beam in comparison to co-pumping. This is due to the additional splice required, and due to the insertion loss of the tapered fiber bundle (TFB) combiner itself. The splice between the gain fiber and the PSC is difficult, since its performance must be simultaneously optimized for both low pump loss (usually requiring a “hot” splice to fully melt the outer glass claddings into a smooth transition), and for low signal loss (usually requiring a “cold” splice to prevent material diffusion out of the core). This generally results in higher losses than if pump and seed beam splices can be optimized separately. The PSC must be able to handle and properly sink uncontrolled lost signal power from the splice and from the internal TFB structure. This is particularly difficult for Tm-doped fibers, where the scattered 2 μm seed beam light is absorbed by most fiber acrylate coatings and can cause them to burn. The PSC imposes significant (typically 0.5-1 m) additional fiber length at the amplifier output, which can partially offset the reduction in nonlinear length afforded by counter-pumping in the first place.

Both co-pumping and counter-pumping can be implemented simultaneously through bi-directional pumping or bi-pumping. This bi-pumped approach does not provide as much of a reduction of the effective power-length product as counter-pumping alone, but it is still an improvement over co-pumping. By splitting the pump power between two ends of the fiber, thermal loads can be split more evenly than by co- or counter-pumping alone. However, bi-pumping still suffers from the integration and power handling challenges of having a PSC at the high power output end of the amplifier. Hence, there is a need for an improved fiber pumping architecture that reduces nonlinear impairments without sacrificing pumping efficiency, increasing fiber temperatures, or suffering the performance and integration issues due to a PSC at the output.

US 2023/0178955 to Goodno, titled, Fiber Laser With Double-Passed Pump Architecture, assigned to the assignee of this application and herein incorporated by reference, provides such an improved fiber pumping architecture. The '955 application discloses a fiber laser amplifier system including a first dual-clad delivery fiber receiving a signal beam and a pump beam, a doped amplifying fiber coupled to the first delivery fiber and receiving the signal beam and the pump beam, and amplifying the signal beam using the pump beam, and a second dual-clad delivery fiber coupled to the amplifying fiber and receiving the amplified signal beam and the pump beam. The system also includes an endcap having an input facet and an output facet. The input facet is coupled to the second delivery fiber and receives the amplified signal beam and the pump beam, and the output facet is configured to pass the amplified signal beam and reflect the pump beam back onto the second delivery fiber to be directed back to the doped amplifying fiber.

In the '955 fiber laser amplifier system, high NA (0.46) pump light is guided as it propagates in the fiber cladding, which is typically on the order of 400 μm diameter, and the delivery fiber is welded to the endcap at a weld joint. When the pump light reaches the weld joint, the fiber cladding waveguide stops, and the pump light freely diverges within the glass body of the endcap as it propagates from the weld joint to the curved exit facet of the endcap, where the pump light is reflected from the dichroic coating. Since the weld joint is located at the center of curvature of the curved exit facet of the endcap, the reflected pump light is re-imaged by the curved facet back onto the weld joint and is coupled back into the fiber cladding waveguide for a second pass. It has been shown in the '955 fiber laser amplifier system that this re-imaging is highly efficient as long as the radius of curvature (ROC) of the exit facet and the endcap thickness are precision-matched so that the re-imaged pump light is in-focus on the weld joint.

The re-imaging endcap design referred to above and described in the '955 application provides many benefits to the fiber laser amplifier system to enable scaling and higher efficiency. However, the endcap design in this fiber laser amplifier system has areas where improvements can be made. For example, it is challenging to precisely fabricate the endcap so that its thickness matches the exit facet ROC. As discussed, mismatch between the endcap thickness and the exit facet ROC will result in defocusing of the re-imaged pump light, and will cause scattering loss of the pump light. This impacts system efficiency and poses a damage risk for handling of the scattered laser power.

Further, it is expensive to fabricate the endcap substrates. Fabrication of an endcap starts as a thick plano-convex lens with a precision ROC polished on one side. The exit facet of the body is then coated with a multi-layer dichroic coating. Then the body of the lens is saw-cut to a taper shape so that the input weld surface of the body is of a similar lateral dimension as the thickness of the fiber, which is necessary to thermally weld the fiber to the endcap. This large number of precision machining steps drives up the manufacturing costs of the endcap. Also, it is challenging to weld the fiber to the endcap. The fiber must be aligned to the center of curvature to within ˜1 μm laterally, which requires skilled engineers using dedicated equipment, and requires active adjustment of the fiber under laser illumination to maximize reflected pump power.

In the endcap design of the '955 fiber laser amplifier system, the endcap dimensions are constrained by the divergence of the cladding pump light. The endcap needs to be short and wide to avoid clipping of the 0.46 NA pump light distribution (0.32 NA within the endcap glass). These dimensional constraints lead to two issues. Specifically, the short endcap length limits beam spreading of the low-NA signal light (typically NA˜0.035 for a 20 μm core fiber) on the exit facet of the endcap. For a multi-kW fiber amplifier, the resulting peak irradiance on the exit facet is multiple MW/cm². This poses a power handling risk because of the thick multi-layer dichroic coating, which is more susceptible to damage and absorptive heating than the thin antireflective (AR) coatings used on traditional endcaps. Longer endcap lengths are desirable to enable more spreading of the signal beam footprint and thereby reduce the peak irradiance on the exit facet. Further, the wide lateral dimensions of the endcap limit integration of multiple fiber amplifiers within a close-packed 1D or 2D array. Such array integration is required for beam-combined laser system integration to scale powers to weapons-class levels (>10 KW). The size and weight (SaW) of the free space combining optics scales with the size of the fiber array. Narrower lateral dimensions of the endcap are desirable to enable tighter packing within a fiber array, thereby reducing SaW of the beam combining optics assembly.

Thus, there is a need for an improved dichroic endcap design that has the same function as the endcap design in the '955 fiber laser amplifier system, but that does not suffer from the limitations of re-imaging discussed above.

### BRIEF DESCRIPTION OF THE DRAWINGS

FIG. 1 is a schematic block diagram of a fiber laser amplifier system including a double-pass pump architecture having a dichroic endcap;

FIG. 2 is an illustration of the gain fiber in the fiber laser amplifier system shown in FIG. 1;

FIG. 3 is an isometric view of a dichroic endcap that employs an adiabatically tapered fiber design;

FIG. 4 is a schematic block diagram of an SBC fiber laser amplifier system including the double-pass pump architecture; and

FIG. 5 is a schematic block diagram of a CBC fiber laser amplifier system including the double-pass pump architecture.

### DETAILED DESCRIPTION OF THE EMBODIMENTS

The following discussion of the embodiments of the disclosure directed to a fiber laser pumping architecture that includes an adiabatically tapered fiber endcap that double-passes the pump light so as to reduce the impact of nonlinear and thermal impairments is merely exemplary in nature, and is in no way intended to limit the disclosure or its applications or uses.

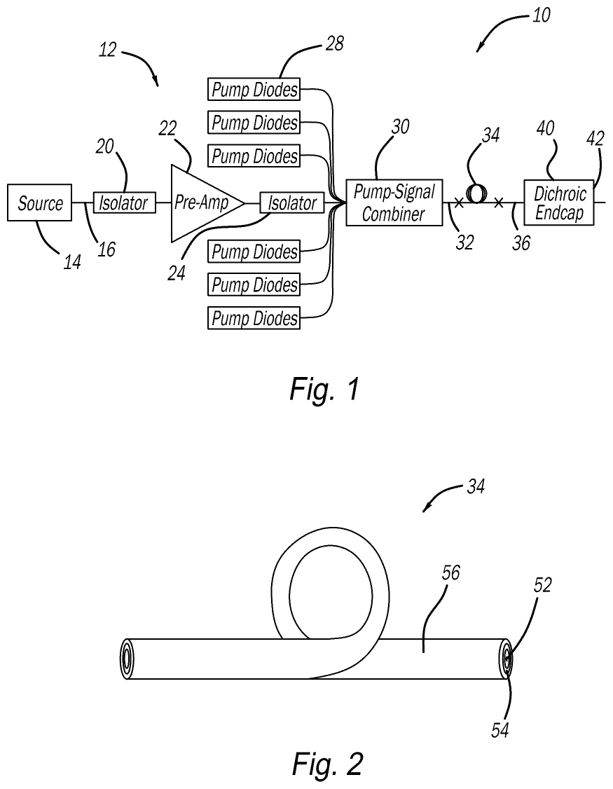

FIG. 1 is a simplified block diagram of a fiber laser amplifier system 10 that includes a single amplification channel 12 having a seed or signal beam source 14 that generates a low power signal beam having a center wavelength 2 on a fiber 16. The source 14 may include a master oscillator (MO), such as a single-longitudinal mode distributed feedback (DFB) diode laser oscillator, and a frequency modulator, such as an electro-optical modulator (EOM). The EOM may receive an applied voltage provided by an amplified radio frequency (RF) electrical drive signal from an RF source (not shown) that provides frequency modulation broadening, such as white noise or pseudo-random bit sequence (PRBS), so that the modulated signal beam has a linewidth that is substantially broadened, which suppresses stimulated Brillouin scattering in downstream high power fiber amplifiers. A low power pre-amplifier 22 receives the broadened signal beam, where the pre-amplifier 22 can be a single fiber amplifier or a serial chain of fiber amplifiers, so as to boost the signal beam power to levels suitable to seed a high power fiber amplifier (typically about 10 W). Optical isolators 20 and 24 on each side of the pre-amplifier 22 allow the signal beam to pass through, but prevent reflected amplified light from returning and entering the source 14, which may otherwise cause damage.

The signal beam along with a plurality of pump beams from pump diodes 28 are combined in a pump-signal combiner 30, such as a suitable tapered fiber bundle, and are sent to a dual-clad delivery fiber 32, such that the pump light propagates in the fiber cladding and the signal light propagates in the fiber core of the fiber 32. The dual-clad delivery fiber 32 is spliced to a doped gain fiber 34 that amplifies the signal beam using the pump beams in a co-pumped manner. FIG. 2 is an illustration of the gain fiber 34 depicting a 20 μm core 52, a 400 μm inner cladding layer 54 and a polymer coating 56. The dual-clad delivery fiber 32 has the same structural elements as the gain fiber 34, except that the core of the delivery fiber 32 is not doped with a laser gain material.

The gain fiber 34 is spliced to a dual-clad delivery fiber 36 that also has the same structural elements as the gain fiber 34, except that the core of the delivery fiber 36 is not doped with a laser gain material. The delivery fiber 36 is coupled to a dichroic endcap 40 that allows for the expansion of the amplified signal beam so as to reduce optical power density when the signal beam reaches the air interface, which might otherwise damage the delivery fiber 36. As will be discussed in detail below, an output end of the endcap 40 is coated with a dichroic and antireflection (AR) coating or layer 42 that reflects the pump beam wavelength and passes the signal beam wavelength. The dichroic layer 42 is similar to the known AR coatings that are typically a stack of thin dielectric layers having the desired optical properties for preventing as much of the signal beam as possible from being reflected back into the endcap 40, but the materials and thicknesses of the layer 42 are designed to also reflect the pump beam wavelengths. The reflected pump beam is directed back into the cladding of the dual-clad delivery fiber 36 so that the reflected pump beam provides additional signal beam amplification in the gain fiber 34 in a counter-propagating manner. This effectively doubles the fiber absorption length of the gain fiber 34 and enables a reduction in the peak fiber heat load equivalent to the benefit of bi-directional pumping without the added complexity, performance impact or development cost of counter-pump couplers. Additionally, by shifting laser gain and signal power toward the output end of the gain fiber 34, the effective nonlinear interaction length for double-passing is only 70% of an equivalent length co-pumped fiber. When coupled with the two-times reduced heat load, the net benefit of implementing double-pass pumping toward reducing nonlinear impairments is three-times compared with co-pumping.

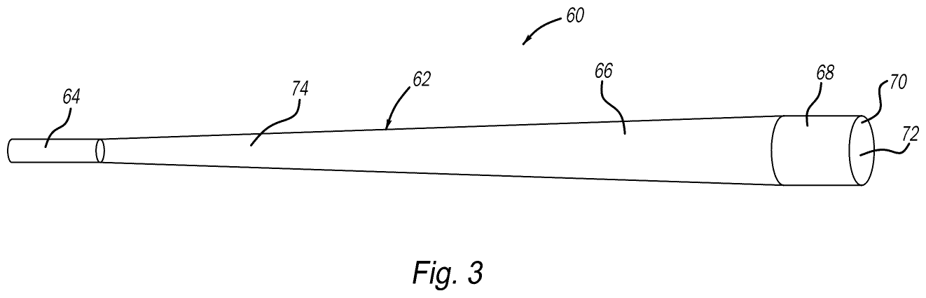

FIG. 3 is an isometric view of a dichroic endcap 60 that employs an adiabatically tapered fiber design. Adiabatic is used herein in the optical sense and means that a perturbation in the endcap 60 is slowly varying. In practice, if the shape of a waveguide varies slowly as a function of its length, guided modes propagating in the waveguide evolve near losslessly as the waveguide parameters change from an input end to an output end of the waveguide. In contrast, if the shape of the waveguide changes abruptly from the input end and to the output end of the waveguide, a large loss would occur at an interface in the waveguide. The endcap 60 is being shown as one non-limiting example of an endcap that can be used as the endcap 40 in the system 10 in that other configurations of the endcap 40 can be provided consistent with the discussion herein.

The endcap 60 includes a glass body 62 having a cylindrical input section 64 that is coupled to a center tapered section 66 that is coupled to a cylindrical output section 68. The delivery fiber 36 would be spliced or optically welded to the input section 64 opposite to the cylindrical output section 68. The high-NA pump light propagates and is guided through the glass body 62 by total internal reflection of the light off of the glass/air interface at an outer surface of the glass body 62. The low-NA signal light propagates in the forward direction through the glass body 62 without intercepting the glass/air interface at the outer surface of the glass body 62. In other words, the signal light freely propagates within the endcap 60 with no guided wave interactions with the outer surface of the glass body 62. The output section 68 includes a plano exit facet 70 having a polished surface and a dichroic coating 72 that, for example, has high reflection (HR) at a 980 nm pump light wavelength to reflect the pump light off of the facet 70 and antireflection (AR) at a 1050 nm signal light wavelength so that the signal light passes through the facet 70. By guiding the pump light through the tapered section 66 to the exit facet 70, the endcap 60 can be made relative long (>1 cm) while keeping the lateral dimension small enough (˜mm-class) to support close-packed array integration for beam-combined laser weapons systems. The low-NA signal light footprint spreads due to diffraction as it propagates through the glass body 62 so that the beam footprint at the exit facet 70 is substantially larger than the core of the delivery fiber 36. The size of the footprint of the signal light at the exit facet 70 increases approximately linearly with the length the endcap 60. The relatively long length of the endcap 60 enables low irradiance and improves resilience against damage to operating environments.

In one non-limiting embodiment, the input section 64 has a diameter of 400 μm to match the diameter of the delivery fiber 36, the output section 68 has a diameter of 1-2 mm and the tapered section 66 has as a length of 1-2 cm. It is noted that the design space for the endcap 60 may be limited. Therefore, it may be desirable to limit the length of the sections 64 and 68 to be as short as possible. In an alternate embodiment, the input section 64 and the output section 68 may be eliminated, where the delivery fiber 36 would be spliced to the input end of the tapered section 66 and the exit facet 70 and the coating 72 would be formed to an output end of the tapered section 66.

In one embodiment, the taper angle of the tapered section 66 is selected to be small enough to ensure adiabatic expansion of 0.46 numerical aperture (NA) pump light injected from the delivery fiber 36, i.e., the taper angle is small enough to ensure that the etendue of the pump light is conserved between the input and output ends of the tapered section 66. Conservation of etendue means that the NA of the pump light decreases at the exit facet 70 of the output section 68 by the ratio of the output beam diameter to the input beam diameter of the pump light. Typically, a long and thin taper geometry is required to meet the adiabatic criterion to conserve etendue, i.e., L>>Dₒᵤₜ, where L is the conical taper length and Dₒᵤₜ is the expanded output diameter of the pump light. Example dimensions meeting this criterion include Dₒᵤₜ=2 mm and L=20 mm. For this example, if the diameter of the input section 64 is 400 μm, then the NA of the pump light at the output of the output section 68 will be decreased by a factor of 2/0.4=5×, i.e., the NA of the pump light transmitted through the exit facet 70 would be reduced from 0.46 to 0.09. For this example, the taper half-angle of the tapered section 66 between the optical propagation axis and the outer conical surface is 40 mrad. Pump light that is reflected off of the exit facet 70 would be adiabatically recompressed back into the 400 μm delivery fiber 36 to recover the original 0.46 NA.

Signal light from the fiber core of the delivery fiber 36 will stop being guided at the input splice plane between the fiber 36 and the input section 64 and will propagate freely through the length of the endcap 60. The dimensions of the endcap 60 are limited by the requirement to avoid clipping of the signal light. For a typical multi-kW fiber, the core diameter of the delivery fiber 36 is on the order of 20 μm, and the NA of the signal light in air is approximately 0.035, which corresponds to a divergence angle in glass of 0.035/n, where n=1.45 is the index of refraction of silica. Hence, the 1/e² beam diameter of the signal light at the exit facet 70 will be 2*NA*L/n, where the NA of the signal light is the 1/e² half angle divergence of the core signal mode. For the example dimensions referred to above with L=20 mm and NA=0.035, the 1/e² exit beam diameter will be 0.97 mm. To pass >99.9% of the signal light power, the diameter aperture of the exit facet 70 should be ˜> twice the beam diameter, or ˜1.93 mm or greater. With these example dimensions, any signal light that is reflected at the exit facet 70 will propagate in the return direction until it reaches the splice plane at the input to the input section 64. The reflected signal light propagation in the return direction may comprise a mixture of free space propagation and guided wave propagation from signal light rays that intercept the glass/air interface at the outer surface of the glass body 62 and undergo total internal reflection (TIR). After reflected signal light propagates in the return direction to the input splice plane at the input to the input section 64, the NA of the reflected signal light will be larger than that of the forward propagating signal light. Furthermore, the footprint of the reflected signal light at the input splice plane at the input to the input section 64 will fully fill the diameter of the input section 64. Both the increased NA and the increased signal light footprint cause the reflected signal light to be geometrically isolated from coupling back into the fiber core of the delivery fiber 36. Such isolation is required to prevent instability for typical fiber amplifiers. Total coupling isolation of −60 dB appears straightforward by combining −30 dB coating loss (R<0.1% at the signal wavelength) with another −30 dB factor due to geometric coupling mismatch of return signal light.

Another geometric design constraint of the endcap 60 is the desire to reduce the signal peak irradiance at the exit facet 70. Dichroic coatings have been shown to withstand irradiances up to 3 MW/cm² without damage. However, during operation it is possible for coated surfaces to become contaminated, reducing the damage threshold. Hence, it is beneficial to design the endcap 60 for as large a signal footprint on the exit facet 70 as possible to spread the laser power out, thus reducing the irradiance, where the lower the irradiance, the lower the risk of optical coating damage, which leads to a minimum endcap length. For example, if the peak irradiance is required to be <3 MW/cm², assuming 5 KW signal power and 20 μm signal core diameter, then the length of the endcap 60 is >11 mm. Combining these three design criteria leads to constraints on the endcap geometry.

It may be desirable to apply an outer coating 74 along the outer surface of the endcap 60, i.e., along the barrel of the body 62. The purpose of the outer coating 74 is to protect the bare glass from handling damage or contamination that could give rise to excess scattering loss or heating. For this purpose, the material of the coating 74 is selected to have a low index of refraction so that it does not affect the local total internal reflection (TIR) of the pump light propagating down the glass body 62. At the input end of the endcap 60 where the NA of the pump light is 0.46, the coating material can be a low refractive index adhesive or a fluoroacrylate polymer similar to the standard material used for dual-clad fiber coatings or for recoating dual-clad fiber splices. At the exit facet 70 of the endcap 60 where the NA of the pump light is adiabatically reduced, there is a wider selection of materials that can be used for the coating 74. For example, the body 62 at the exit facet 70 could be coated with magnesium fluoride (MgF₂) or calcium fluoride (CaF₂) whose index of refraction of 1.38, which contains the NA of the pump light to be 0.4. For another example, the body 62 at the exit facet 70 of the endcap 60 could be coated with fluorine-doped silicon dioxide (SiO₂), which contains the NA of the pump light to be 0.22 (this is a standard material used for fiber claddings). The coating 74 must be thick enough to fully contain the evanescent wave of the pump light (typically a few microns thickness). This allows handing, mechanical contact, or contamination on the outer surface of the coating 74 without impact to guidance or power handling of the pump light. Similarly, an endcap without the coating 74 could be mechanically attached to a submount that is either made from a low index of refraction material or coated with such a material to provide protection and optical isolation from the environment. Such an approach could provide for mechanical contact points for affixing the endcap 60 into an optical mount or as an element within an array of fiber/endcap channels. The contact need not be continuous over the entire barrel of the endcap 60, so that mounting pads could be selectively defined for contact or for localized coating treatment.

The glass substrate that the endcap 60 is formed from can be fabricated on a fiber glass processing workstation by heating and pulling a stock large diameter coreless fiber to draw down and taper its diameter. This tapering process is widely performed across the fiber-optic industry to manufacture tapered fiber couplers, pump combiners, and other components. The tapered fiber can be cleaved to the approximate desired final length, and the large diameter exit surface can be polished using standard optical polishing equipment to form the exit facet 70. Finally, the dichroic coating 72 can be applied to the polished exit facet 70 using standard thin film coating deposition methods, such as ion-beam sputtering (IBS). The untapered sections 64 and 68 may ease mechanical integration and splicing, and are accounted for in calculating the endcap design space, but have no impact on the design concept for adiabatic expansion.

It is expected that manufacturing of the endcap 60 will be substantially easier because of the elimination of critical tolerances by eliminating re-imaging. Unlike the re-imaging endcap, there is no need to manufacture the tapered endcap 60 to a specific length within the broad parameter space. The plano exit facet 70 is easy to polish to high quality in comparison to a precision radiused endcap surface. The fiber down-draw process is mass-producible, and the starting material is low-cost fiber stock, as opposed to starting with expensive, long-lead material (typically Suprasil 3001 or equivalent) needed for the bulk re-imaging endcaps. Further, there is no need for manual cutting or machining of the endcap 60 to form the taper. The fiber welding process is simply a matter of aligning the fiber claddings, which is fully automated in commercial splicers operated by technicians with no need for active laser illumination or alignment.

It is also expected that the adiabatic taper of the endcap 60 will substantially reduce scatter losses. Any tolerance mismatch for the re-imaged endcap design results in clipping of pump light at the weld joint between the delivery fiber 36 and the endcap upon return. Since the pump light for the endcap 60 with the adiabatic taper is guided at all locations, there is no propensity for tolerance mismatch and near −100% coupling is expected. Less scatter loss also makes it easier to contain and manage any stray light. This is particularly important for applications that require integration of multiple endcaps into arrays where stray light from different channels can cause additive thermal deformation or temperature rise.

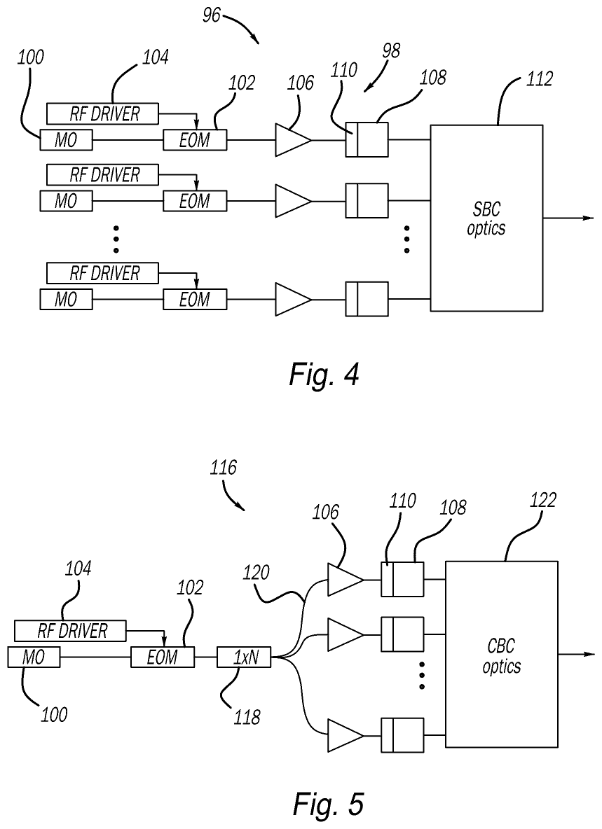

FIG. 4 is a simplified block diagram of an SBC fiber laser amplifier system 96 that includes a plurality of amplification channels 98 each having an MO 100 that generates a signal beam, where the MOs 100 in the different channels 98 generate the signal beams at different wavelengths. The signal beam is sent to an EOM 102 that receives an applied voltage provided by an RF driver 104 that provides frequency modulation broadening. The signal beam is then amplified by a fiber amplifier 106 and terminates in an endcap 110 of the type discussed above. The plurality of endcaps 110 are affixed together to form a close-packed beam launcher array 108 that launches an amplified beam from the plurality of channels 98. The amplified beam is then sent through free space to SBC combining optics 112 including a grating (not shown) that has a periodic structure formed into the grating so that when the individual amplified beams each having a slightly different wavelength and angular direction are redirected by the periodic structure so that all of the beams diffract from the diffraction grating in the same direction as a combined output beam.

FIG. 5 is a simplified block diagram of a CBC fiber laser amplifier system 116 where like elements to the system 96 are identified by the same reference number. The system 116 includes a single MO 100 that generates a signal beam that is split by a beam splitter 118 into multiple signal beams that are amplified by the amplifiers 106. The amplified beams from the beam launchers 108 are sent to CBC optics 122 that combine all of the amplified beams into a combined output beam.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A fiber laser amplifier system comprising:
at least one signal beam source generating a signal beam;
at least one pump beam source generating a pump beam;
a beam combiner for combining the signal beam and the pump beam;
a first dual-clad delivery fiber coupled to the beam combiner and receiving the combined pump beam and signal beam;
a doped amplifying fiber coupled to the first delivery fiber and receiving the combined pump beam and signal beam, said amplifying fiber amplifying the signal beam using the pump beam;
a second dual-clad delivery fiber coupled to the amplifying fiber and receiving the amplified signal beam and the pump beam; and
an endcap including an input end and an output end, said input end being coupled to the second delivery fiber and receiving the amplified signal beam and the pump beam and said output end having an output facet configured to pass the amplified signal beam and reflect the pump beam back into the second delivery fiber to be directed back to the doped amplifying fiber, said endcap further including a tapered section between the input end and the output end having a taper angle that provides adiabatic expansion of a numerical aperture (NA) of the pump beam, and wherein the pump beam propagates along and through the endcap by total internal reflection and the amplified signal beam propagates through the endcap without total internal reflection.

2. The system according to claim 1 wherein the taper angle of the tapered section is small enough to ensure that the etendue of the pump beam is conserved between the input end and the output end, where conservation of etendue means that the NA of the pump beam decreases at the exit facet by the ratio of an output beam diameter of the pump beam to an input beam diameter of the pump beam.

3. The system according to claim 1 wherein the output facet includes a dichroic coating that is antireflective at the wavelength of the signal beam and highly reflective at the wavelength of the pump beam.

4. The system according to claim 1 wherein the tapered section has a length greater than 1 cm.

5. The system according to claim 4 wherein the input end has a diameter of about 400 μm and the output end has a diameter greater than 1 mm.

6. The system according to claim 5 wherein the tapered section has a length between 1 and 2 cm and the output end has a diameter between 1 and 2 mm.

7. The system according to claim 1 wherein the taper half-angle of the tapered section between an optical propagation axis of the amplified signal beam and the pump beam and an outer conical surface of the tapered section is about 40 mrad.

8. The system according to claim 1 wherein the endcap includes a cylindrical input section coupled to the tapered section and the second delivery fiber at the input end and cylindrical output section coupled to the tapered section at the output end, said output facet being formed to the output section.

9. The system according to claim 1 wherein the exit facet has a plano output surface.

10. The system according to claim 1 wherein the endcap is a glass body and wherein the glass body includes a protective outer coating that protects the glass from handling damage or contamination that could cause excess scattering loss or heating, and wherein the material of the protective coating is selected to have a lower index of refraction than the index of refraction of the glass.

11. The system according to claim 10 wherein the material of the coating is fluoroacrylate polymer at the input end and the material of the coating is magnesium fluoride (MgF₂), calcium fluoride (CaF₂) or fluorine-doped silicon dioxide (SiO₂) at the output end.

12. The system according to claim 1 wherein the beam combiner is a taper fiber bundle.

13. The system according to claim 1 wherein the fiber laser amplifier system is a coherent beam combining (CBC) fiber laser amplifier system and the at least one pump beam source, the beam combiner, the first delivery fiber, the doped amplifying fiber and the second delivery fiber are part of one fiber channel of a plurality of fiber channels.

14. The system according to claim 1 wherein the fiber laser amplifier system is a spectral beam combining (SBC) fiber laser amplifier system and the at least one pump beam source, the beam combiner, the first delivery fiber, the doped amplifying fiber and the second delivery fiber are part of one fiber channel of a plurality of fiber channels.

15. An optical endcap comprising an input end and an output end, said input end receiving an amplified signal beam and a pump beam and said output end having an output facet configured to pass the amplified signal beam and reflect the pump beam back towards the input end, said endcap including a tapered section between the input end and the output end having a taper angle that provides adiabatic expansion of a numerical aperture (NA) of the pump beam, and wherein the pump beam propagates along and through the endcap by total internal reflection and the amplified signal beam propagates through the endcap without total internal reflection.

16. The endcap according to claim 15 wherein the taper angle of the tapered section is small enough to ensure that the etendue of the pump beam is conserved between the input end and the output end, where conservation of etendue means that the NA of the pump beam decreases at the exit facet by the ratio of an output beam diameter of the pump beam to an input beam diameter of the pump beam.

17. The endcap according to claim 15 wherein the output facet includes a dichroic coating that is antireflective at the wavelength of the signal beam and highly reflective at the wavelength of the pump beam.

18. The endcap according to claim 15 wherein the tapered section has a length greater than 1 cm.

19. The endcap according to claim 15 wherein the exit facet has a plano output surface.

20. The endcap according to claim 15 wherein the endcap is a glass body and wherein the glass body includes a protective outer coating that protects the glass from handling damage or contamination that could cause excess scattering loss or heating, and wherein the material of the protective coating is selected to have a lower index of refraction than the index of refraction of the glass.
